(19) United States
(12) Patent Application Publication
(10) Pub. No.: US 2006/0070089 A1
(43) Pub. Date: Mar. 30, 2006

(54) Method and apparatus for dynamic replacement of device drivers in the operating system (OS) kernel

(76) Inventors: Shahid Shoaib, San Jose, CA (US); Manuel Roman, Sunnyvale, CA (US); Nayeem Islam, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/000,751

(22) Filed: Nov. 30, 2004

Related U.S. Application Data
(60) Provisional application No. 60/603,342, filed on Aug. 20, 2004.

(51) Int. Cl. G06F 13/00

(52) U.S. Cl. 719/321

(57) ABSTRACT

A method and apparatus for dynamic replacement of device drivers in the operating system (OS) kernel are described. In one embodiment, the method comprising receiving a request to add a device driver to an operating system and dynamically adding the device driver to the operating system while user application and operating system processes are being performed.

This application claims the benefit of U.S. Provisional Application No. 60/603,342, entitled “Method and Apparatus for Dynamic Replacement of Device Drivers in the OS Kernel,” filed Aug. 20, 2004, incorporated herein by reference.

### FIELD OF THE INVENTION

The present invention is related to the field of operating systems for computer systems and other various devices, such as mobile devices (e.g., cellular phones, personal digital assistants, etc.); more particularly, the present invention is related to invoking and replacing device drivers in computer systems.

### BACKGROUND

Operating systems control the operation of computer systems. Today, however, even mobile devices such as cellular phones have operating systems. FIG. 1 illustrates a traditional operating system (OS). Referring to FIG. 1, applications 101 are in user space 102 and legacy device drivers 103 are in kernel space 105, along with legacy kernel services 106 and system call dispatcher 104. When one of applications 101 in user space 102 calls one of the legacy device drivers 103, a trap to the kernel occurs, resulting in system call dispatcher 104 being called. System call dispatcher 104 then calls the appropriate method on the device driver.

Operating systems use the device drivers to communicate with hardware or software (in the case of virtual device drivers). Research has shown that device drivers account for the majority of operating system failures. For example, 85% of Windows XP failures are due to bad drivers. Device drivers have error rates up to three to seven times higher than the rest of the kernel. In mobile devices, such failures can result in costly recalls for the operator.

Operating systems such as Linux, FreeBSD and Microsoft Windows provide mechanisms for replacing device drivers. Existing mechanisms for replacing device drivers inside the operating system kernel suffer from two key problems. First, all applications using the driver must be shutdown and the operating system must be restarted is most cases. Second, the device driver losses all previous state after the replacement has been completed. This not only causes inconvenience to the end user but is also highly undesirable if mobile devices act like servers and must always be available in the future.

U.S. Pat. No. 5,564,051 (hereinafter “the '051 patent”), entitled “Automatic Update of Static and Dynamic Files at a Remote Network Node in Response to Calls Issued by or for Application Programs,” discloses remote upgrading of network files. The '051 patent discloses that a comparison is made between the files currently available at a first processor (work station) and the up-to-date files held at a second processor (host). A list of actions to be taken is then compiled and files are downloaded to the first processor to replace out-of-date files to add or create files in order to augment those already present, and to delete any obsolete files no longer required by the application. However, the '051 patent does not address non-intrusive upgrading of operating system kernels and does not address dynamic replacement of device drivers.

U.S. Pat. No. 6,560,614 (hereinafter “the '614 patent”), entitled “Nonintrusive Update of Files,” describes a method for updating files while they are open. The '614 patent discloses updating a file that is currently open by allowing current users to continue accessing the original file while redirecting new users to an updated version. When user activity permits, the updated version is substituted for the original file. An auxiliary program detects when a server application attempts to access an out-of-date version of a file and redirects the access call to the up-to-date file version. When no users are accessing the out-of-date file version, the up-to-date version of the file is substituted, thereby allowing access to the most recent file version without creating errors for users who are accessing the older file version. New updates of files are transferred from a master site to a temporary location, accessible intermediate location, and finally to a permanent location. Furthermore, the method described in the '614 patent is designed for use with files stored in a filesystem and cannot be used for replacing code that is already running on a system. Thus, the method is only applicable to user-space applications and cannot be used inside the OS kernel.

U.S. Pat. No. 6,502,176 (hereinafter “the '176 patent), entitled “Computer System and Methods for Loading and Modifying a Control Program Without Stopping the Computer System Using Reserve Areas,” discloses allowing for non-intrusive updating of a control program such as the OS but requires changes to the core OS kernel for it to work.

U.S. Pat. No. 6,314,567 (hereinafter “the '567 patent”), entitled “Apparatus and Method for Transferring State Data When Performing On-Line Replacement of a Running Program Code and Data,” as well as U.S. Pat. No. 6,141,683 (hereinafter “the '603 patent”), entitled “Method for Remotely and Reliably Updating of the Software on a Computer with Provision for Roll Back,” are only applicable for user-space programs and cannot be used to dynamically replace device drivers inside the operating system kernel.

U.S. Pat. No. 5,930,515 (hereinafter “the '515 patent”), entitled “Apparatus and Method for Upgrading a Computer System Operating System,” discloses updating operating systems but requires the use of two separate memories attached to two different processors to perform the upgrade.

### SUMMARY OF THE INVENTION

A method and apparatus for dynamic replacement of device drivers in the operating system (OS) kernel are described. In one embodiment, the method comprises receiving a request to add a device driver to an operating system and dynamically adding the device driver to the operating system while user application and operating system processes are being performed.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a traditional operating system (OS).

FIG. 2A is a block diagram of functional components in the system of architecture of the present invention.

FIG. 2B is a flow diagram of one embodiment of a process for replacing device drivers.

FIG. 3 is a more detailed block diagram of one embodiment of the overall system architecture.

FIG. 4 illustrates one embodiment of a process performed by the device driver invocation manager.

FIG. 5 illustrates one embodiment of a device driver invocation protocol.

FIG. 6 illustrates one embodiment of a device driver installation protocol.

FIG. 7 illustrates one embodiment of a device driver replacement protocol.

FIG. 8A is a flow diagram of one embodiment of a prepare replacement process.

FIG. 8B is a flow diagram of one embodiment of a device driver replacement process.

FIG. 8C illustrates one embodiment of a device driver replacement protocol.

FIG. 9 illustrates one embodiment of a device driver inspection protocol.

FIG. 10 is a block diagram of one embodiment of a mobile device.

FIG. 11 is a block diagram of one embodiment of a computer system.

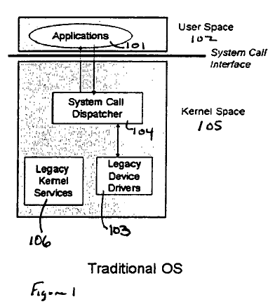

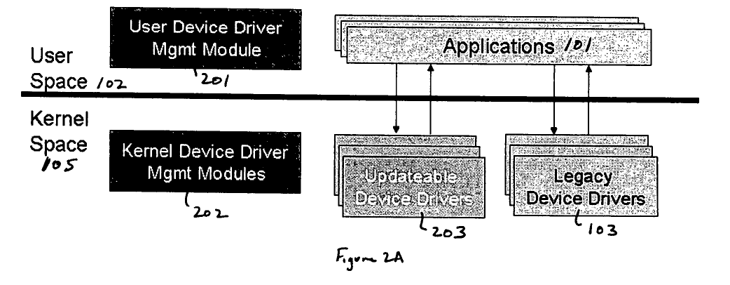

### DETAILED DESCRPTION OF THE PRESENT INVENTION

A method and apparatus for replacing device drivers are described. One embodiment of the present invention allows for non-intrusive updating of operating system (OS) device drivers. Embodiments of the present invention add functionality to existing operating systems for dynamically updating device drivers while maintaining application transparency and ensuring the safety of the dynamic update functionality. Dynamically updating a device driver may include one or more of installation, removal, and replacement of device drives.

In one embodiment, the new update functionality is achieved through a set of new user level application programming interfaces (APIs) that extend the semantics of existing device driver invocations. In one embodiment, the semantics of the system call interface for device drivers are changed without affecting any user or kernel space applications. The new semantics ensure that a system call to a device driver does not result in a crash if the device driver is being replaced. This is accomplished by (i) providing transparent interception and redirection of application requests, which is for achieving safety of replacements, (ii) providing mechanisms for registration, replacement and removal of device drivers inside the kernel, and (iii) providing an interfacing mechanism that ensures the functionality can operate as kernel modules without changing kernel source code.

In one embodiment, the present invention is realized by adding three new kernel modules into the operating system as well as a user device driver manager application at the user level. The user device driver manager application can be used for remote over-the-air (OTA) management of device drivers in an operating system.

In one embodiment of the present invention, a system call dispatcher transfers control to a device driver invocation manager (DDIM) for device driver calls. The DDIM can then call the appropriate method on the actual device driver itself. The interception layer introduced by the DDIM helps in the realization of one embodiment of the present invention because it allows for the determination of safe points in time when dynamic replacement can be performed. In one embodiment, a dynamic replacement system for operating system device drivers according to the present invention has the following features. First, the device driver replacement does not affect existing processes in both user and kernel space, respectively (with the exception of kernel modules performing the replacement). In other words, the replacement is transparent to user/kernel processes and they continue operating as if nothing happened. Second, the application programming interfaces (APIs) for device drivers is not changed, and user space applications are able to continue using existing APIs to call device drivers. Third, the device driver replacement is safe in that replacement does not crash any other user/kernel process. Fourth, code inside the kernel itself is not changed, other than the kernel modules that support the replacement functionality. Thus, one embodiment of the present invention provides for updating the OS functionality in a modular way without changing a single line of code inside the core kernel.

The dynamic replacement techniques described herein are applicable to a number of operating systems. The teachings herein enable any existing operating system meeting the requirement defined herein to be extended with dynamic replacement functionality. Embodiments of the present invention are applicable to any operating system that provides a mechanism for registering device drivers in the kernel, where the device driver can register handler methods with the core kernel; provides a mechanism that allows device drivers to determine their identity once the handler methods described above are invoked; provides a mechanism that allows device drivers to register interrupt handlers with the operating system; and provides a mechanism that allows device drivers to communicate with each other. Operating systems, including most UNIX operating systems (e.g., Linux, FreeBSD) and Microsoft Windows operating systems meet these requirements.

Note that the techniques described herein achieve a fine grained dynamic replacement of device drivers without requiring multiple memories and processors.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

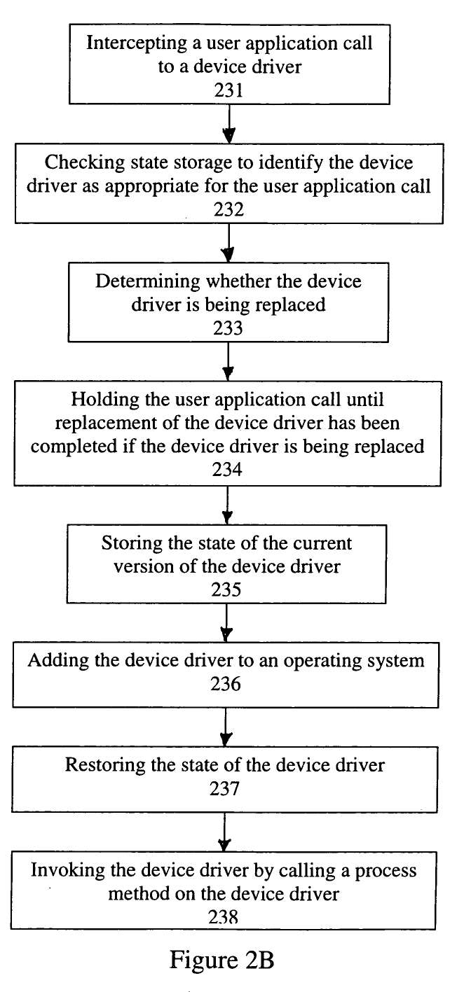

FIG. 2A illustrates a block diagram of functional components in the system architecture of the present invention. Referring to FIG. 2A, as in the traditional operating system, applications 101 are in user space 102 and communicate with legacy device drivers 103 in kernel space 105. However, in the system architecture set forth in FIG. 2A, updateable device driver 203 are also in kernel space 105 and communicate with applications 101. Moreover, user space 102 includes a user device driver management module 201, which performs interception of device driver requests and is described in more detail below. Also, kernel space 105 includes kernel device driver management modules 202, which perform the installation, removal and replacement of device drivers and are described in more detail below.

FIG. 2B is a flow diagram of one embodiment of a process. The process is performed by processing logic that may comprise hardware (e.g., circuitry, dedicated logic, etc.), software (such as is run on a general purpose computer system or a dedicated machine), or a combination of both.

Referring to FIG. 2B, the process begins by processing logic intercepting a user application call to a device driver (processing block 231).

In response to intercepting the user application call, processing logic checks state storage to identify the device driver as appropriate for the user application call (processing block 232).

Once the device driver has been identified, processing logic determines whether the device driver is being replaced (processing block 233). If the device driver is being replaced, processing logic holds the user application call until replacement of the device driver has been completed if the device driver is being replaced (processing block 234) and stores the state of the current version of the device driver (processing block 235). In one embodiment, if a device driver is being replaced, processing logic removes its device driver specific information from memory (e.g., state storage) and unregisters a stub method associated with the device driver from the operating system kernel.

Thereafter, processing logic adds the device driver to an operating system (processing block 236). In one embodiment, the device driver is dynamically added transparently to user application and operating system processes being performed. In one embodiment, the device driver is dynamically added to the operating system kernel while ensuring safety of the operating system and user applications calling the device driver (e.g., the operating system and/or the user application does not crash during replacement of the device driver).

In one embodiment, adding the device driver comprises registering the device driver with the operating system kernel and registering the device driver with state storage to enable routing of incoming user application calls to the device driver. In one embodiment, registering the device driver with the operating system kernel is performed using stub interception. To that end, in one embodiment, registering the device driver includes registering only a stub method with the operating system kernel for the device driver interface.

In one embodiment, registering a device driver also includes storing device driver specific information in memory (e.g., state storage).

Once the device driver has been replaced, processing logic restores the state of the device driver (processing block 237).

If the device driver is not being replaced or after any replacement has been performed, processing logic invokes the device driver (processing block 238). In one embodiment, processing logic invokes the device driver by calling a process method on the device driver. In one embodiment, when an application calls an interface method of the driver device, its associated stub is called.

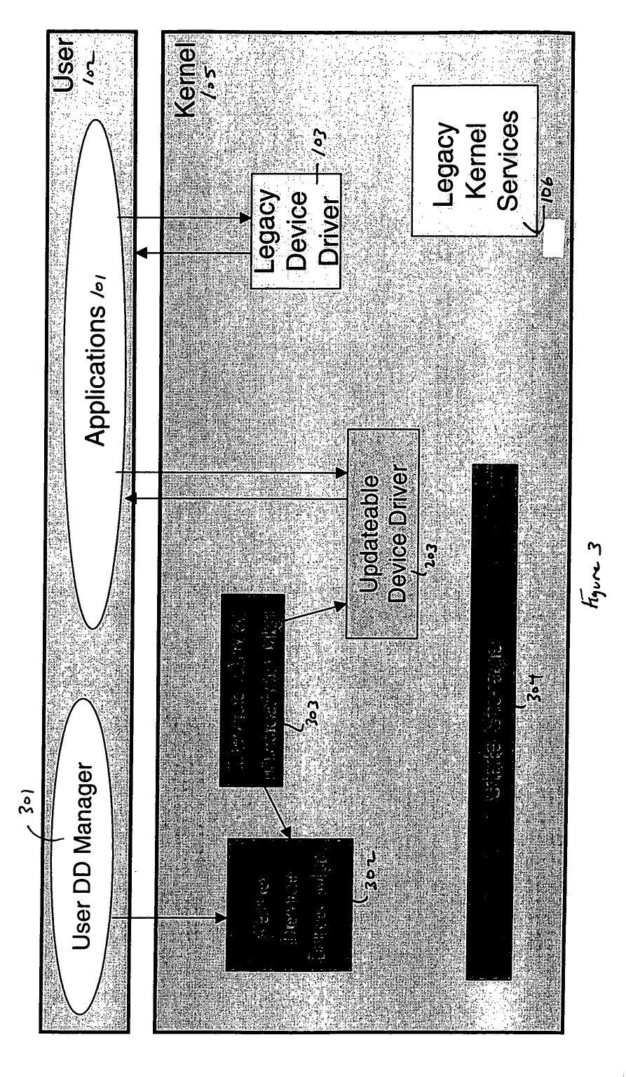

FIG. 3 is a more detailed block diagram of one embodiment of the overall system architecture. Referring to FIG. 3, the system architecture consists of two logical parts that are added to an existing operating system to achieve the functionality described herein: (i) the kernel level components, which includes kernel device driver invocation manager (DDIM) 303, kernel device driver manager (KDDM) 302 and state storage 304; and (ii) a user level application, which is referred to herein as user device driver manager (UDDM) 301.

The system architecture may be included in a general purpose computer system or a dedicated machine. In one embodiment, the system architecture is included in a mobile device, such as, for example, a cellular phone.

State Storage

State storage 304 saves the state of updateable device drivers 203. In one embodiment, state storage 304 provides an API to other kernel modules to access, store and retrieve its contents. In one embodiment, state storage 304 is implemented in memory as a tuple container such as, for example, a hashtable in which keys are stored as strings and values are pointers to memory regions. The keys identify the state data associated with each of updatable device drivers 203 and the pointers are used to identify the memory locations where the state data for each of updatable device drivers 203 is stored. The state data may include global variables and heap allocations. In one embodiment, all global variables and heap allocations are indexed in state storage 304. The data may be used to help with driver replacement. State storage 304 facilitates dynamic driver replacement by ensuring that memory persists during the course of the replacement. Furthermore, state storage 304 provides a uniform interface to inspect the memory structures of device drivers.

Device Driver Invocation Manager (DDIM)

In one embodiment, device driver invocation manager (DDIM) 303 performs request interception and memory safety across protection domains.

In one embodiment, DDIM 303 intercepts all user application calls to updateable device drivers 203. After intercepting the call, DDIM 303 checks state storage 304 to find the appropriate device driver to call and then invokes that device driver. If the target device driver is being replaced, DDIM 303 holds all incoming application calls for the device driver until the replacement has been completed.

In one embodiment, the interception of incoming application calls is achieved by registering stub methods with the operating system kernel for corresponding device driver interfaces. When an application calls an interface method on a device driver, the stub gets called. At this point, DDIM 303 of kernel 105 can make sure that it is safe to call the target device driver and perform the actual invocation.

In one embodiment, in order to guarantee that API calls between kernel and user protection domains do not result in a crash due to bad pointer references, an embodiment of the present invention relies on the kernel APIs copy_from_user( ) and copy_to_user( ) to ensure that memory is safely copied between the two protection domains. This is described in more detail below.

In one embodiment, DDIM 303 is implemented as a traditional device driver and acts as the entry point for all dynamic device driver update functionality described herein. A user level application uses OS standard API calls (as shown in the protocol descriptions below) in order to interact with DDIM 303.

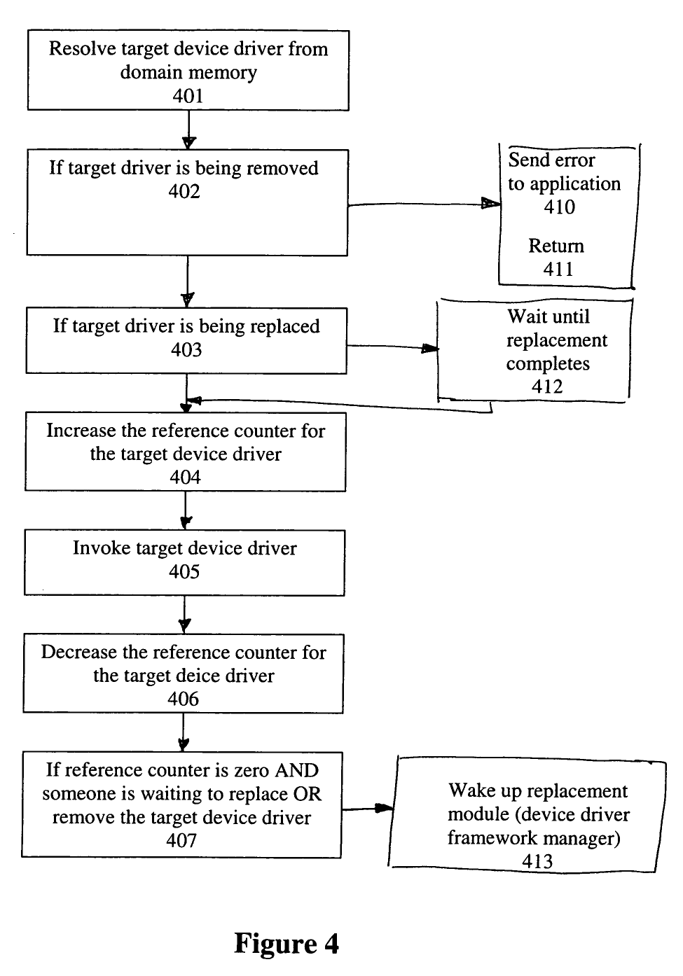

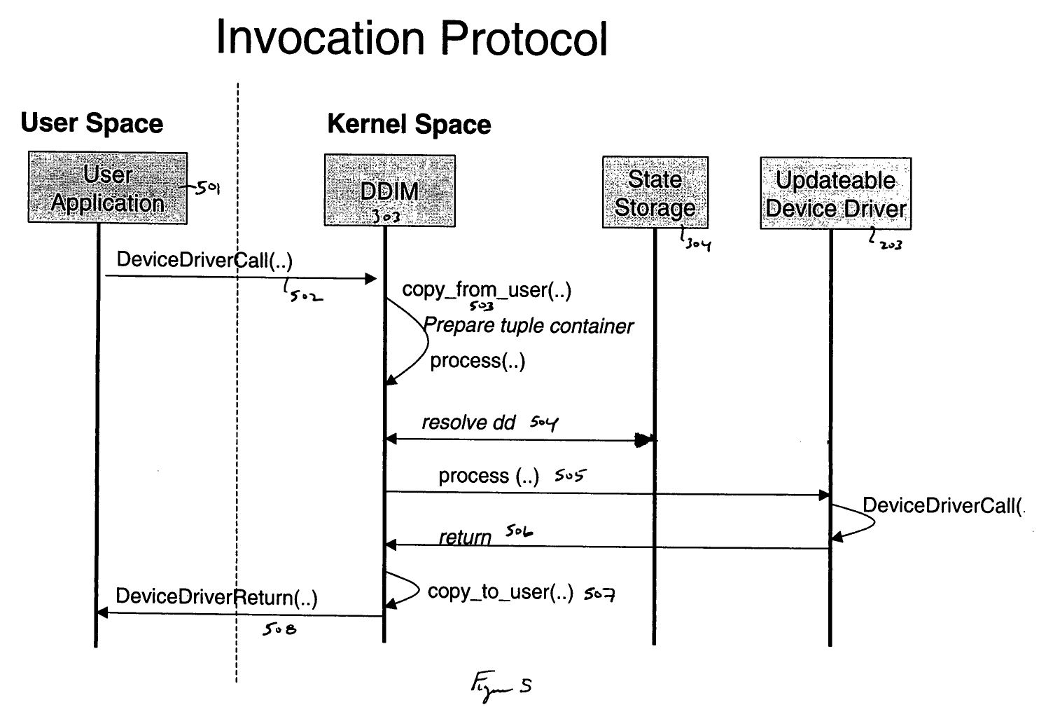

One embodiment of a process performed by DDIM 303 is shown in FIG. 4. In one embodiment, sections are included in the code in order to guarantee that DDIM 303 performs safe replacement of device drivers while avoiding deadlock between processes. The process sets forth FIG. 4 is performed by processing logic which may comprise hardware (e.g., circuitry, dedicated logic, etc.), software (such as is run on a general purpose computer system or a dedicated machine), or a combination of both.

Referring to FIG. 4, the process begins by processing logic determining the target device driver from state storage 304 (processing block 401). Next, processing logic determines whether the target device driver is being removed (processing block 402). If it is, processing logic sends an error to the application (processing block 410) and returns (processing block 411).

Processing logic tests whether the target device driver is being replaced (processing block 403). If it is, processing logic waits until the replacement completes (processing block 412).

After any target device driver replacement, processing logic increases the reference counter for the target device driver (processing block 404). The reference counter indicates the number of outstanding requests that exist at any one time for the device driver.

Thereafter, processing logic invokes the target device driver (processing block 405). After invoking the target device driver, processing block decreases the reference counter for the target device driver (processing block 406). Processing logic tests whether the reference counter is 0 and whether the system is waiting to replace or remove the target device driver (processing block 407). If so, processing logic wakes up the replacement module in the device driver framework manager (processing block 413). Otherwise, the process ends.

Kernel Device Driver Manager (KDDM)

In one embodiment, KDDM 302 is a kernel module that is responsible for installing, removing and replacing device drivers from the operating system kernel. In one embodiment, KDDM 302 interfaces with UDDM 301 at the user level through DDIM 303.

In one embodiment, device driver installation involves registering the new device driver with (i) the operating system as a kernel module using the stub interception methods defined in kernel DDIM 303, and (ii) state storage 304 so that the kernel DDIM 303 can route incoming calls to the driver and finally, call the initialization routine of the device driver. One embodiment of the device driver installation protocol is described below in conjunction with FIG. 6.

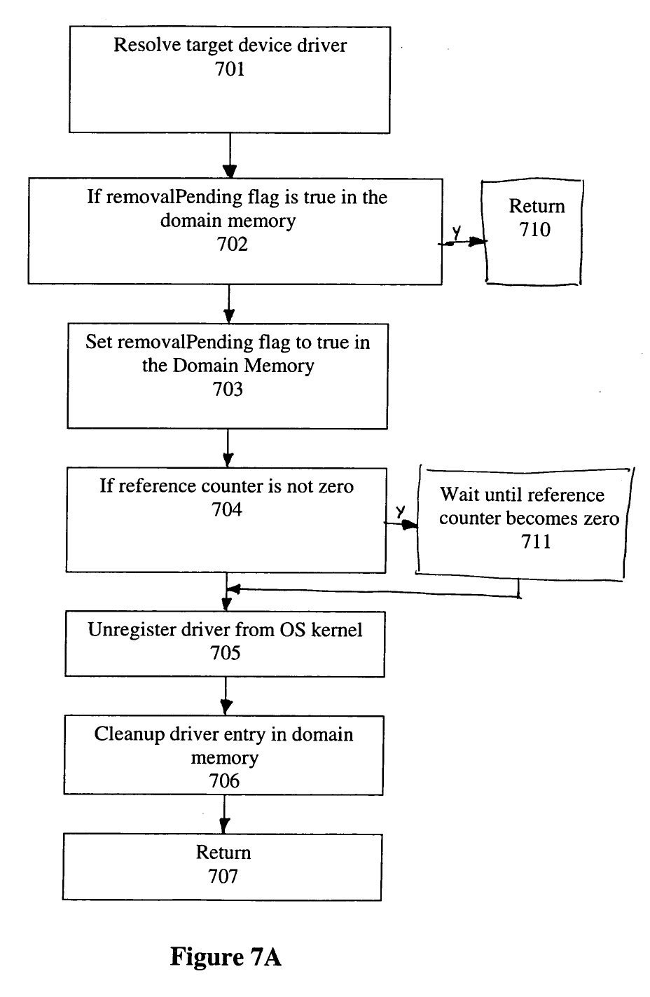

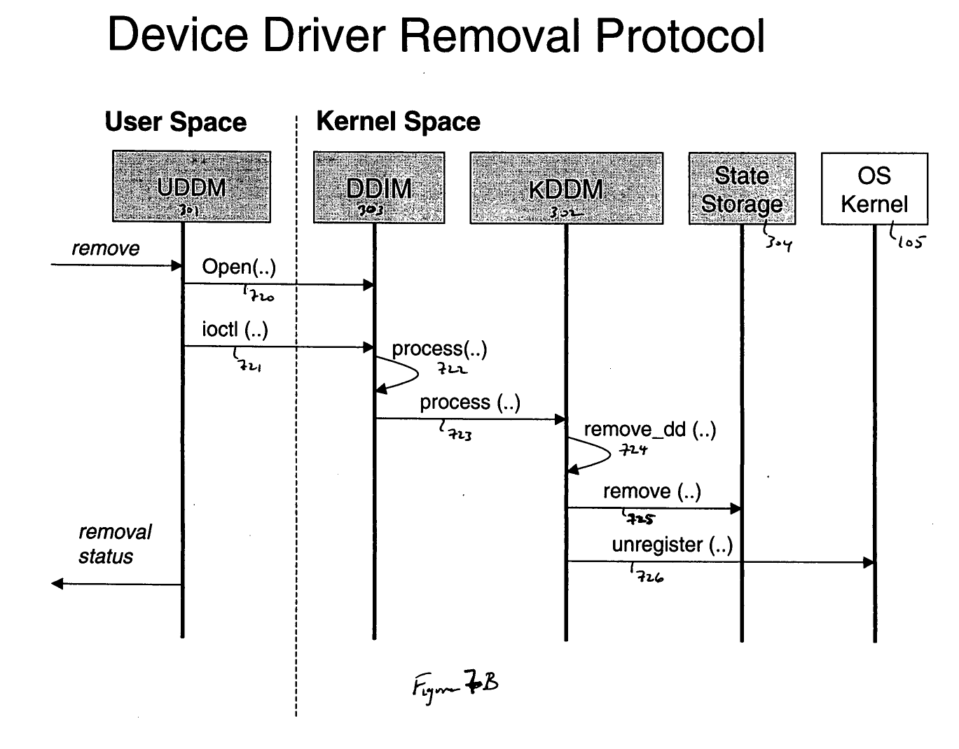

In one embodiment, device driver removal involves (i) setting a pendingRemoval flag to true so that DDIM 303 can hold all incoming calls to the device driver, (ii) making sure that the system is in a safe state by checking that no application is using the target device driver, (iii) unregistering the target device driver from the OS kernel, and (iv) removing any memory used by the device driver. One embodiment of the device driver removal protocol is described below in conjunction with FIG. 7B.

In one embodiment, device driver replacement involves two steps. The first step, referred to herein as prepare replacement, involves KDDM 302 (i) setting a pendingReplacement flag to true so that device driver invocation manager 303 can hold all incoming calls to the device driver, (ii) making sure that the system is in a safe state by checking that no application is using the target device driver, (iii) unregistering the target device driver from the OS kernel, and (iv) updating state storage 304 with driver status information.

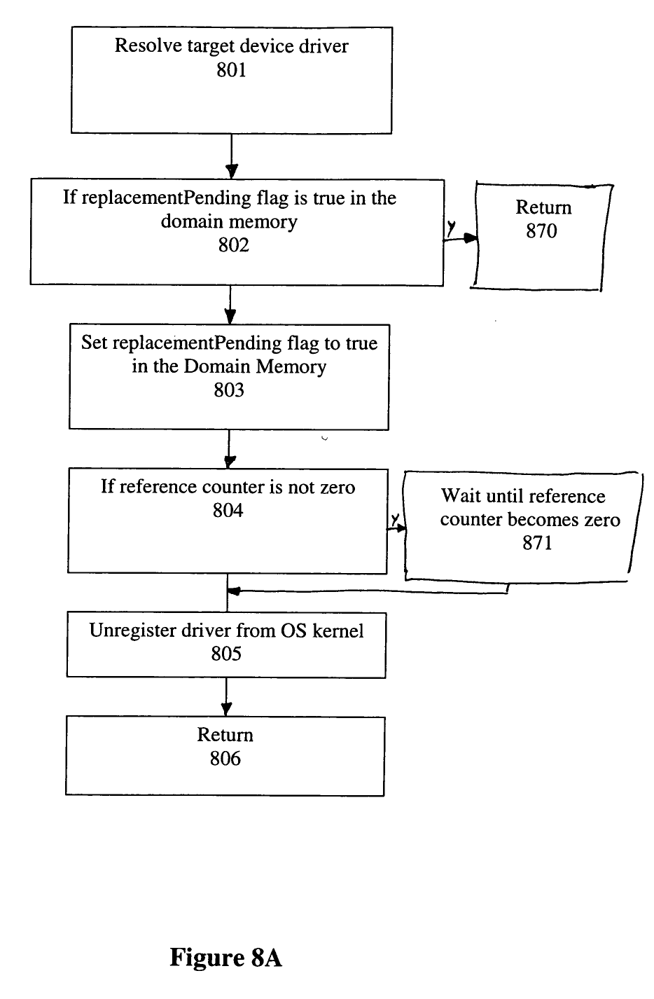

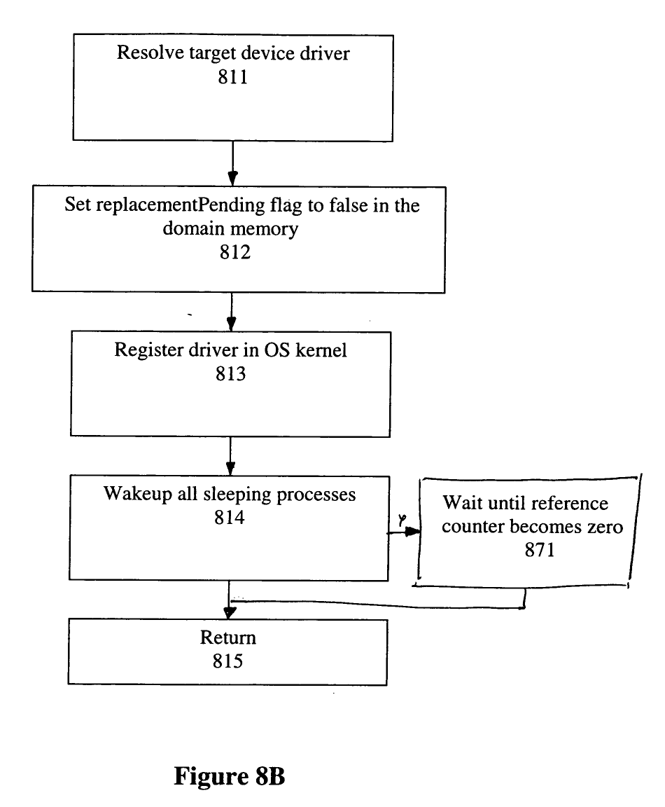

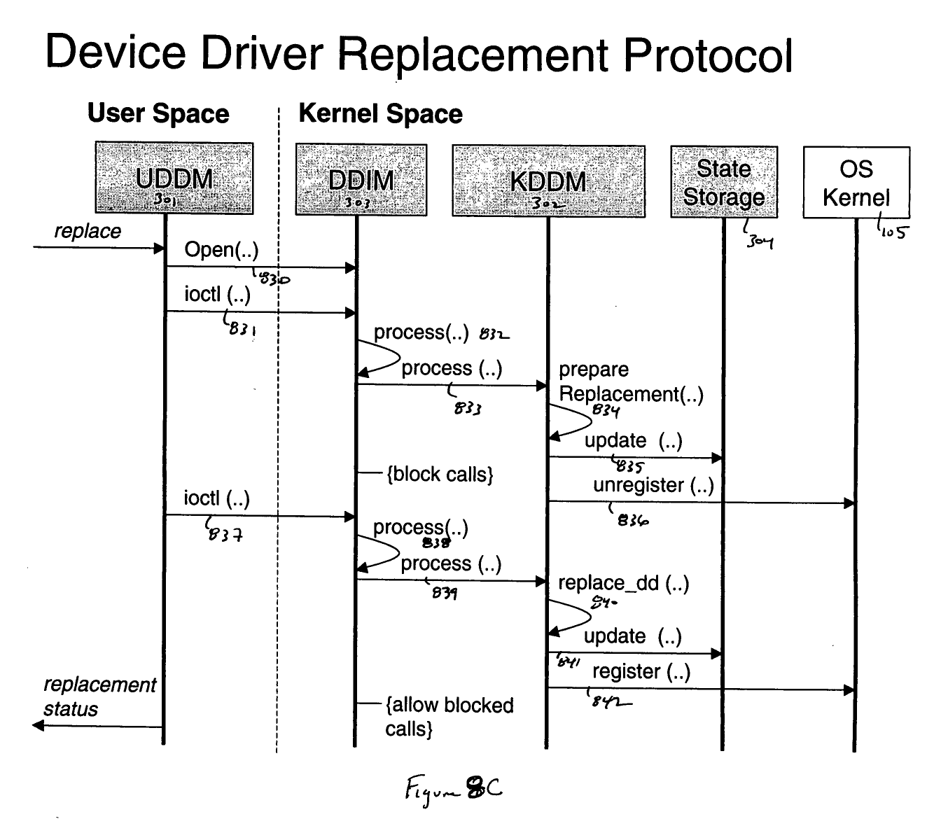

At this point, KDDM 302 is ready to insert the new device driver into the OS kernel. This insertion involves (i) updating the driver entry for the replacement device driver in state storage 304 so that device driver invocation manager 303 can route incoming calls to the driver, (ii) calling the initialization routine of the replacement device driver, and (iii) waking up all processes that were waiting to access the device driver. In one embodiment, replacement of the device driver results in a new handle being given (updated) to the operating system to enable the device driver to be called. One embodiment of the device driver replacement protocol is described below in conjunction with FIG. 8C.

User Device Driver Manager (UDDM)

In one embodiment, UDDM 301 is a user space application that interfaces with KDDM 302 in order to install, remove and replace drivers from the operating system kernel. UDDM 301 may be used in multiple ways. In one embodiment, UDDM 301 is a command line utility (software). In another embodiment, UDDM 301 as a backend Over-The-Air (OTA) device management tool. In one embodiment, UDDM 301 is installed with a privilege level of administrator (or root) so that only the systems administrator can perform dynamic update of device drivers. Thus, in one embodiment, UDDM 301 can be invoked by the system administrator locally or by an Over-The-Air (OTA) entity having appropriate privilege level.

In one embodiment, the command line parameters for UDDM 301 are as follows:
uddm [-command] [-name . . . ]
Options:
command
install: Install a new Device Driver
remove: Remove a device driver from the kernel
replace: Replace a device driver with a new one
inspect: Inspect the state of device drivers installed in the kernel
name
name of the device driver.
   Updateable Device Drivers

In one embodiment, each of device drivers 203 has the following six features.

1. A device driver has a process( ) method that takes as input a pointer to a tuple container (such as a hashtable) and returns void.

2. The process( ) method described above retrieves the pointer to the actual method to invoke by doing a tuple container lookup with the key “MethodName” and then invoke it.

3. The invoked method uses the tuple container pointer to retrieve and return parameters to callers.

4. The device driver registers its Major number and a function pointer to its process method with state storage 304.

5. The device driver does not do any registration with the kernel itself.

6. All global variable and memory allocated on the heap are stored and accessed through state storage 304.

Exemplary Protocols

Embodiments for the protocols for the invocation, installation, removal and replacement of device drivers using the framework described above are given below.

Driver Invocation Protocol

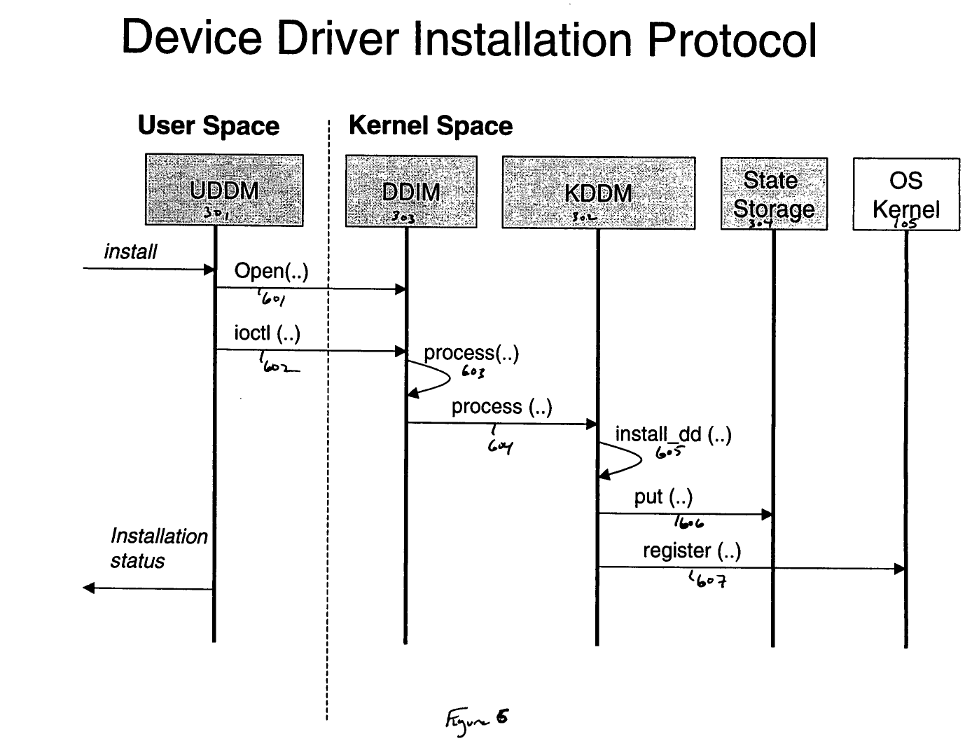

One embodiment of a device driver invocation protocol is shown in FIG. 5. Referring to FIG. 5, when a user level application makes an API call (Device Driver Call( ) 502) on a updateable device driver, the call is intercepted by device driver invocation manager (DDIM) 303. DDIM 303 first copies all user space memory references to the kernel space by using copy_from_user( ) system API 503. Next, DDIM 303 creates a new tuple container and puts all the parameters of the DeviceDriverCall 502 in the tuple container. At this point, DDIM 303 tries to resolve the target device driver from state storage 304. This is the process by which DDIM 303 determines which device driver is being invoked and determines whether the device driver is being replaced. If the target device driver is being replaced, DDIM 303 holds all incoming application calls until the replacement has been completed. After the target device driver is resolved successfully, DDIM 303 calls the process( ) method 505 on the target device driver. The process method of the device driver forwards the request to the appropriate method (Device Driver Call( )).

To summarize, when an application calls an interface method on a device driver, the appropriate stub on DDIM 303 gets called. At this point, DDIM 303 can make sure that it is safe to call the target device driver and perform the actual invocation.

When the device driver call returns 506, it is intercepted by DDIM 303 again, which makes sure that any memory is properly copied back to the user space using the copy_to_user( ) system API 507, and then DDIM 303 sends a return (Device Driver Return( ) 508) to user application 501.

Driver Installation Protocol

FIG. 6 is one embodiment of a device driver installation protocol. Referring to FIG. 6, driver installation starts with an external entity, such as an OTA application or system administrator, invoking UDDM 301 using an install request. UDDM 301 then opens DDIM 303 using the standard Open( ) method call 601. After DDIM 303 has been successfully opened, UDDM 301 performs an ioct1( ) call 602 on DDIM 303 which asks DDIM 303 to call KDDM 302. DDIM 302 then looks up KDDM 303 from state storage 304 using a process( ) method 603 and invokes the process( ) method 604 on KDDM 303. The process method on KDDM 303 resolves the method name to the call as “install_dd” and calls the installed_dd method 605.

After resolving the method name, installation involves registering the new device driver with (i) the operating system as a kernel module using the stub interception methods defined in kernel device driver invocation manager 303 using a register call 607, and (ii) state storage 304 using a put( ) call 606. In this way, DDIM 303 can route incoming calls to the driver and finally perform the actual invocation.

Driver Removal Protocol

FIG. 7A is a flow diagram of one embodiment of the device driver removal process. The process is performed by processing logic which may comprise hardware (e.g., circuitry, dedicated logic, etc.), software (such as is run on a general purpose computer system or a dedicated machine), or a combination of both.

Referring to FIG. 7A, the process begins by processing logic resolving the target device driver to determine which device driver is to be removed (processing block 701). Next, processing logic determines if a removalpending flag is true (processing block 702), thereby indicating that removal of the target device driver is already occurring. If true, then processing logic returns (processing block 710). If not, processing logic sets the removalpending flag to true (processing block 703).

Next, processing logic determines whether the reference counter indicating the number of currently pending requests for the target device driver is not zero (processing block 704). If the reference counter is not zero, processing logic waits until the reference counter becomes zero (processing block 711). If the reference counter is zero or after the reference counter becomes zero, processing logic unregisters the device driver from the OS kernel (processing block 705) and clears the driver entry in state storage 304 (processing block 706). Thereafter, processing logic returns (processing block 707).

FIG. 7B illustrates one embodiment of the device driver removal protocol. Referring to FIG. 7B, driver removal starts with an external entity, such as an OTA application or system administrator, invoking UDDM 301 with a remove request. UDDM 301 then opens DDIM 303 using the standard Open( ) method call 720. After DDIM 303 device driver has been successfully opened, UDDM 301 performs an ioct1( ) call 721 on DDIM 303 which asks DDIM 303 to call KDDM 302. DDIM 303 then looks up KDDM 302 from state storage 304 using process( ) method 722 and invokes the process( ) method 723 on KDDM 302. In response, KDDM runs process method to resolve the method name to call as “remove_dd” and calls the remove_dd method 724. Remove_dd( ) method 724 removes the device driver from the OS kernel using an unregister( ) call 726 as well as state storage 304 using remove( ) call 725.

Driver Replacement Protocol

FIG. 8A is a flow diagram of one embodiment of a prepare replacement process. The process is performed by processing logic which may comprise hardware (e.g., circuitry, dedicated logic, etc.), software (such as is run on a general purpose computer system or a dedicated machine), or a combination of both.

Referring to FIG. 8A, processing logic initially resolves the target device driver to identify the device driver that is to be replaced (processing block 801). Next, processing logic tests whether the replacementpending flag is true in state storage 304 (processing logic 802). If it is, replacement is already pending and processing logic returns (processing block 870). If not, processing logic sets the replacementpending flag to true in state storage 304 (processing block 803). Next, processing logic tests whether the reference counter is not zero (processing block 804), indicating requests to the device driver are still pending. If it is not zero, processing logic waits until the reference counter becomes 0 (processing block 871).

When the reference counter is zero, processing logic unregisters the device driver from the OS kernel (processing block 805) and returns (processing block 806).

FIG. 8B is a flow diagram of one embodiment of a device driver replacement process. The process is performed by processing logic which may comprise hardware (e.g., circuitry, dedicated logic, etc.), software (such as is run on a general purpose computer system or a dedicated machine), or a combination of both.

Referring to FIG. 8B, processing logic resolves the target device driver to determine the device driver to be replaced (processing block 811). Once the target device driver has been resolved, processing logic sets the replacementpending flag to false in state storage 304 (processing block 812. Processing logic then registers the device driver in the OS kernel (processing block 813). Processing logic then wakes up all sleeping processes related to the target device driver (processing block 814) and returns (processing block 815).

FIG. 8C illustrates one embodiment of a device driver replacement protocol. Referring to FIG. 8C, the replacement process starts with an external entity, such as an OTA application or system administrator, invoking UDDM 301 using a replace request. UDDM 301 then opens DDIM 303 using the standard Open( ) method call 830. After DDIM 303 has been successfully opened, UDDM 301 performs an ioct1( ) call 831 on the DDIM 303 which asks DDIM 303 to call KDDM 302. DDIM 303 then looks up KDDM 302 from state storage 304 using protocol( ) method 832 and invokes the process( ) method 833 on KDDM 302. In response to process method 833, KDDM 302 resolves the method name to call as “prepareReplacement” and calls that method 834. Prepare_replacement( ) method 834 ensures the system is in a safe state to do the replacement by updating state storage 304 using update( ) call 835 and unregistering the device driver from the OS kernel with an unregister call 836. In one embodiment, updated( ) call 835 updates keys, pointers, global variables and/or heap allocations.

At this point, UDDM 301 is ready to insert the replacement driver into the system. To do so, UDDM 301 performs another ioct1( ) call 837 on DDIM 303 which causes the replace_dd( ) method 840 to be invoked on KDDM 302. Replace_dd( ) method 840 causes the actual replacement by updating state storage 304 using an update( ) call 841 and registering the device driver with the OS kernel using a register( ) call 842. UDDM 301 wakes up all sleeping processes when its done.

Driver Inspection Protocol

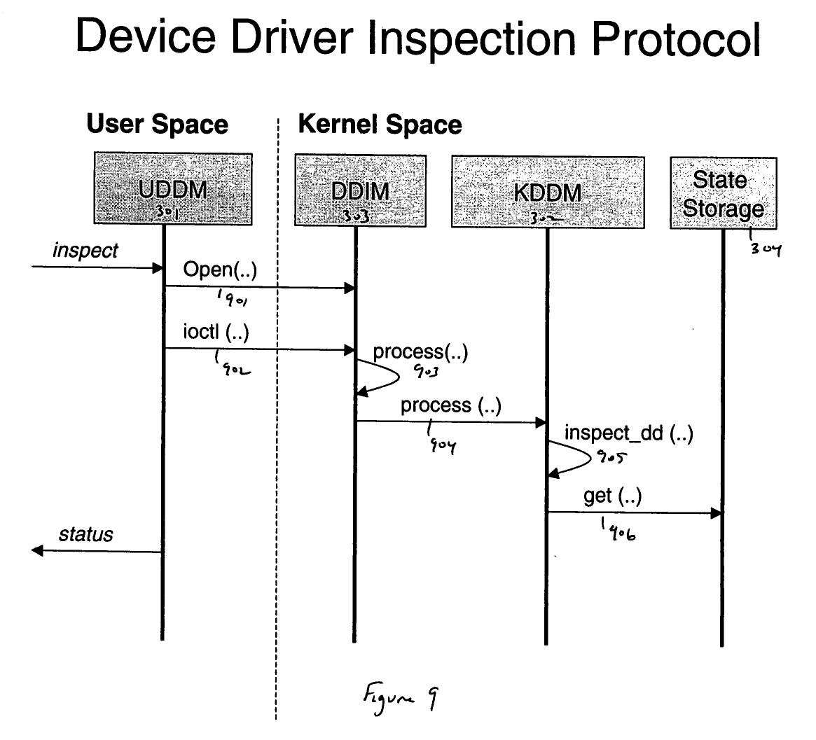

FIG. 9 is one embodiment of a device driver inspection protocol. This protocol is invoked when UDDM 301 wants to inspect the updateable device drivers installed in the system as well as the accompanying state of those drivers. Referring to FIG. 9, the process starts with an external entity, such as an OTA application or system administrator, invoking UDDM 301 with an inspect request. UDDM 301 then opens DDIM 303 using the standard Open( ) method call 901. After DDIM 303 has been successfully opened, UDDM 301 performs an ioct1( ) call 902 on DDIM 303 which asks DDIM 303 to call KDDM 302. DDIM 303 then looks up KDDM 302 from state storage 304 and invokes process( ) method 904 on KDDM 303. In response to process method 904, KDDM 302 resolves the method name to call as “inspect_dd” and calls that method using inspect_dd method 905. The inspect_dd( ) method 905 retrieves state information about installed device drivers from state storage 304 using get( ) call 906 and returns it to the application. Thus, UDDM 301 is able to obtain a snapshot of the current state of the system at any time.

New Semantics for Device Driver Invocation

Embodiments of the present invention use new semantics to the standard device driver API supported by the operating system.

If a device driver is invoked while it is being replaced, the API call is intercepted by DDIM 303 until the replacement has been successfully completed. Once the replacement is completed successfully, the API call is allowed to proceed. In one embodiment, a timeout mechanism is provided to ensure that if an API call is blocked and the replacement does not complete by a preset timeout value, an error is returned to the application.

If the replacement is unsuccessful, KDDM 303 can restore the original device driver or remove it altogether. In the later case, an appropriate error message is returned to the application. If a device driver is invoked while it is being removed, the API call is intercepted by DDIM 303 and an appropriate error message is returned to the application.

An Exemplary Mobile Device

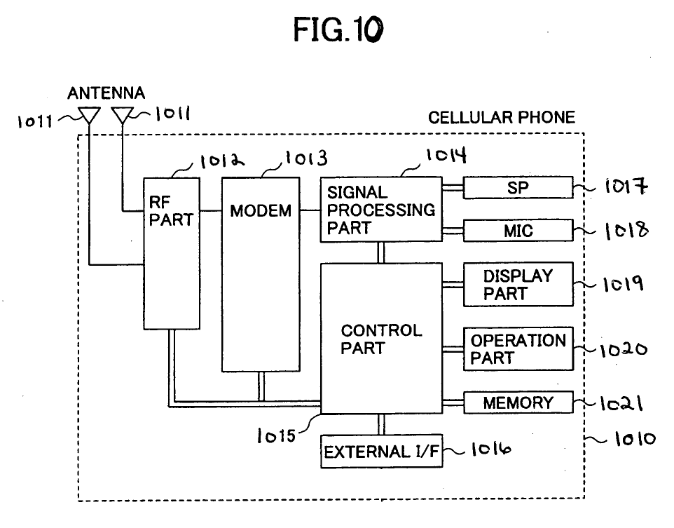

FIG. 10 is a block diagram of one embodiment of a cellular phone.

Referring to FIG. 10, the cellular phone 1010 includes an antenna 1011, a radio-frequency transceiver (an RF unit) 1012, a modem 1013, a signal processing unit 1014, a control unit 1015, an external interface unit (external I/F) 1016, a speaker (SP) 1017, a microphone (MIC) 1018, a display unit 1019, an operation unit 1020 and a memory 1021.

The external terminal 1030 includes an external interface (external I/F) 1031, a CPU (Central Processing Unit) 1032, a display unit 1033, a keyboard 1034, a memory 1035, a hard disk 1036 and a CD-ROM drive 1037.

CPU 1032 in cooperation with the memories of cellular phone 1010 (e.g., memory 1021, the memory 1035, and hard disk 1036) cooperate to perform the operations described above.

An Exemplary Computer System

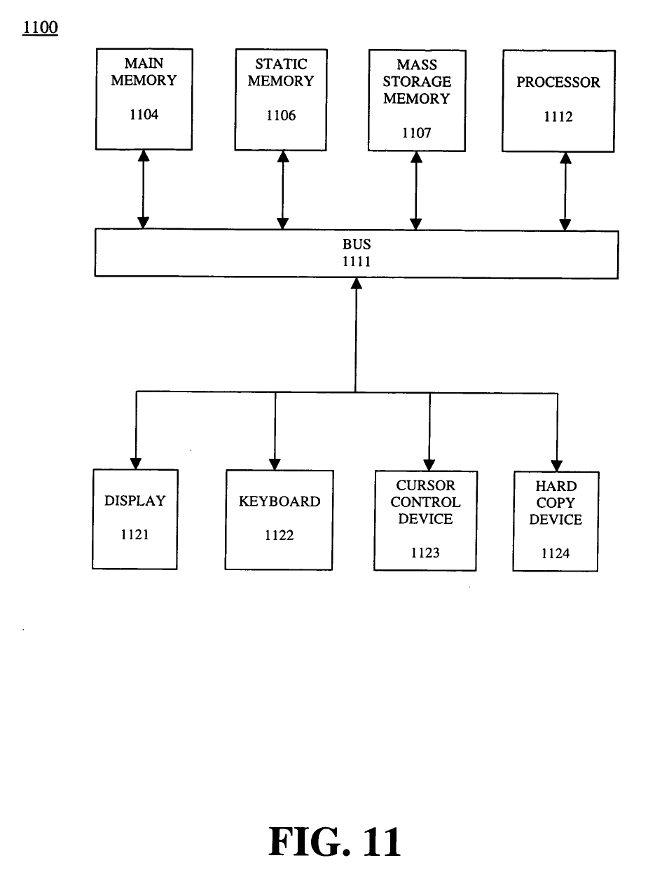

FIG. 11 is a block diagram of an exemplary computer system that may perform one or more of the operations described herein. Referring to FIG. 11, computer system 1100 may comprise an exemplary client or server computer system. Computer system 1100 comprises a communication mechanism or bus 1111 for communicating information, and a processor 1112 coupled with bus 1111 for processing information. Processor 1112 includes a microprocessor, but is not limited to a microprocessor, such as, for example, Pentium™, PowerPC™, Alpha™, etc.

System 1100 further comprises a random access memory (RAM), or other dynamic storage device 1104 (referred to as main memory) coupled to bus 1111 for storing information and instructions to be executed by processor 1112. Main memory 1104 also may be used for storing temporary variables or other intermediate information during execution of instructions by processor 1112.

Computer system 1100 also comprises a read only memory (ROM) and/or other static storage device 1106 coupled to bus 1111 for storing static information and instructions for processor 1112, and a data storage device 1107, such as a magnetic disk or optical disk and its corresponding disk drive. Data storage device 1107 is coupled to bus 1111 for storing information and instructions.

Computer system 1100 may further be coupled to a display device 1121, such as a cathode ray tube (CRT) or liquid crystal display (LCD), coupled to bus 1111 for displaying information to a computer user. An alphanumeric input device 1122, including alphanumeric and other keys, may also be coupled to bus 1111 for communicating information and command selections to processor 1112. An additional user input device is cursor control 1123, such as a mouse, trackball, trackpad, stylus, or cursor direction keys, coupled to bus 1111 for communicating direction information and command selections to processor 1112, and for controlling cursor movement on display 1121.

Another device that may be coupled to bus 1111 is hard copy device 1124, which may be used for printing instructions, data, or other information on a medium such as paper, film, or similar types of media. Furthermore, a sound recording and playback device, such as a speaker and/or microphone may optionally be coupled to bus 1111 for audio interfacing with computer system 1100. Another device that may be coupled to bus 1111 is a wired/wireless communication capability 1125 to communication to a phone or handheld palm device.

Note that any or all of the components of system 1100 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving a request to add a device driver to an operating system;
dynamically adding the device driver to the operating system while user application and operating system processes are being performed.

2. The method defined in claim 1 wherein the request to add the device driver is a request to replace a first version of the device driver with a second version of the device driver.

3. The method defined in claim 1 wherein the device driver is dynamically added transparently to user application and operating system processes being performed.

4. The method defined in claim 1 wherein dynamically adding the device driver to the operating system occurs while ensuring safety of the operating system.

5. The method defined in claim 1 further comprising:
storing the state of the device driver if the device driver is being replaced; and
restoring the state of the device driver after replacement.

6. The method defined in claim 1 further comprising:
intercepting a user application call;
checking state storage to identify the appropriate device driver for the user application call; and
invoking the device driver to handle the user application call.

7. The method defined in claim 6 further comprising:
determining whether the device driver is being replaced;
holding the user application call until replacement of the device driver has been completed if the device driver is being replaced.

8. The method defined in claim 6 wherein invoking the device driver comprises calling a process method on the device driver.

9. The method defined in claim 1 further comprising:
registering the device driver with the operating system kernel; and
registering the device driver with state storage to enable routing of incoming user application calls to the device driver.

10. The method defined in claim 9 wherein registering the device driver with the operating system kernel is performed using stub interception.

11. The method defined in claim 1 further comprising:
intercepting an application programming interface (API) call to a device driver.

12. A method comprising:
intercepting a user application call to a device driver;
checking state storage to identify the device driver as appropriate for the user application call; and
invoking the device driver.

13. The method defined in claim 12 further comprising dynamically adding the device driver to an operating system while user application and operating system processes are being performed.

14. The method defined in claim 13 wherein the device driver is dynamically added transparently to user application and operating system processes being performed while ensuring safety of the operating system.

15. The method defined in claim 12 further comprising:
determining whether the device driver is being replaced; and
holding the user application call until replacement of the device driver has been completed if the device driver is being replaced.

16. A method comprising:
intercepting a user application call to a device driver;
checking state storage to identify the device driver as appropriate for the user application call;
determining whether the device driver is being replaced;
holding the user application call until replacement of the device driver has been completed if the device driver is being replaced; and
invoking the device driver.

17. An article of manufacture having one or more recordable media storing instructions thereon which, when executed by a system, cause the system to perform a method comprising:
receiving a request to add a device driver to an operating system;
dynamically adding the device driver to the operating system while user application and operating system processes are being performed.

18. The article of manufacture defined in claim 17 wherein the request to add the device driver is a request to replace a first version of the device driver with a second version of the device driver.

19. The article of manufacture defined in claim 17 wherein the device driver is dynamically added transparently to user application and operating system processes being performed.

20. The article of manufacture defined in claim 17 wherein dynamically adding the device driver to the operating system occurs while ensuring safety of the operating system.

21. The article of manufacture defined in claim 17 wherein the method further comprises:
storing the state of the device driver if the device driver is being replaced; and
restoring the state of the device driver after replacement.

22. The article of manufacture defined in claim 17 wherein the method further comprises:
intercepting a user application call;
checking state storage to identify the appropriate device driver for the user application call; and
invoking the device driver to handle the user application call.

23. The article of manufacture defined in claim 22 wherein the method further comprises:
determining whether the device driver is being replaced;
holding the user application call until replacement of the device driver has been completed if the device driver is being replaced.

24. The article of manufacture defined in claim 22 wherein invoking the device driver comprises calling a process method on the device driver.

25. The article of manufacture defined in claim 17 wherein the method further comprises:
registering the device driver with the operating system kernel; and
registering the device driver with state storage to enable routing of incoming user application calls to the device driver.

26. The article of manufacture defined in claim 25 wherein registering the device driver with the operating system kernel is performed using stub interception.

27. An article of manufacture having one or more recordable media storing instructions thereon which, when executed by a system, cause the system to perform a method comprising:
intercepting a user application call to a device driver;
checking state storage to identify the device driver as appropriate for the user application call; and
invoking the device driver.

28. The article of manufacture defined in claim 27 further comprising dynamically adding the device driver to an operating system while user application and operating system processes are being performed.

29. The article of manufacture defined in claim 28 wherein the device driver is dynamically added transparently to user application and operating system processes being performed while ensuring safety of the operating system.

30. The article of manufacture defined in claim 27 further comprising:
determining whether the device driver is being replaced; and
holding the user application call until replacement of the device driver has been completed if the device driver is being replaced.

31. An article of manufacture having one or more recordable media storing instructions thereon which, when executed by a system, cause the system to perform a method comprising:
intercepting a user application call to a device driver;
checking state storage to identify the device driver as appropriate for the user application call;
determining whether the device driver is being replaced;
holding the user application call until replacement of the device driver has been completed if the device driver is being replaced; and
invoking the device driver.

32. An apparatus comprising:
means for receiving a request to add a device driver to an operating system;
means for dynamically adding the device driver to the operating system while user application and operating system processes are being performed.

33. An apparatus comprising:
means for intercepting a user application call to a device driver;
means for checking state storage to identify the device driver as appropriate for the user application call;
means for determining whether the device driver is being replaced;
means for holding the user application call until replacement of the device driver has been completed if the device driver is being replaced; and
means for invoking the device driver.

34. An architecture for use in cooperation with an operating system kernel, the architecture comprising:
a device driver invocation manager to receive a request to add a device driver to an operating system;
a kernel device driver manager to dynamically add the device driver to the operating system while user application and operating system processes are being performed.

35. The architecture defined in claim 34 wherein the device driver invocation manager transparently intercepts and redirects one or more application requests to the device driver.

36. The architecture defined in claim 34 wherein the device driver invocation manager transparently intercepts and redirects application requests using stub methods with the operating system kernel, such that a stub is called when an application calls an interface method on the device driver.

37. The architecture defined in claim 34 wherein the kernel device driver manager stores device driver specific information in a storage component.

38. The architecture defined in claim 34 wherein the kernel device driver manager registers one or more stub methods for the device driver with the operating system kernel.

39. The architecture defined in claim 34 wherein the kernel device driver manager adds the device driver to the operating system to replace a previous device driver.

40. The architecture defined in claim 39 wherein the kernel device driver manager preserves the state of the previous device driver and blocks further invocations of the device driver while ensuring all current requests are flushed before dynamically adding the device driver to the operating system.

41. The architecture defined in claim 39 wherein the current device driver manager removes the device driver by removing device driver specific information from a storage component and unregistering one ore more stub methods for the device driver from the operating system kernel.

42. The architecture defined in claim 34 further comprising a user device driver manager to receive a command indicating an operation to perform with respect to the device driver.

43. The architecture defined in claim 34 wherein the user device driver manager is invoked by an external entity.

44. The architecture defined in claim 43 wherein the external entity is a command line interface.

45. The architecture defined in claim 43 wherein the external entity is an over-the-air management tool.

46. The architecture defined in claim 42 wherein the user device driver manager opens the device driver using an open method call.

47. The architecture defined in claim 42 wherein the user device driver manager performs an ioct1 call on the device driver invocation manager to cause the device driver invocation manager to call the kernel device driver manager.

48. The architecture defined in claim 47 wherein device driver invocation manager looks up the kernel device driver manager in storage and invokes a process method along the kernel device driver manager.

49. The architecture defined in claim 48 wherein the process method causes the kernel device driver manager to resolve the method name to call.

50. The architecture defined in claim 49 wherein the method name to call is resolved as the method to replace the device driver.

51. The architecture defined in claim 50 wherein the method ensures that the operating system is in a safe state to perform the replacement of the device driver.

52. The architecture defined in claim 51 wherein the user device driver manager inserts the device driver into the system to replace an existing device driver by invoking a call on the device driver invocation manager.

53. The architecture defined in claim 52 wherein the call is an ioct1 call on the device driver invocation manager which causes a replaced device driver method to be invoked by a kernel device driver manager.

54. An architecture for use in cooperation with an operating system kernel, the architecture comprising:
a device driver invocation manager to
intercept device driver calls from one or more user applications,
checking state storage to identify a device driver appropriate for each user application call,
hold any user application call until replacement of the appropriate device driver if the device driver is being replaced, and
generate process calls to the appropriate device driver to invoke the device driver; and
a kernel device driver manager responsive to process calls from the device driver invocation manager to install, remove, and replace one or more device drivers from the operating system kernel; and
one or more device drivers responsive to process calls from the device driver invocation manager to perform user application calls.

55. The architecture defined in claim 54 wherein the device driver invocation manager is implemented as a device driver.

56. The architecture defined in claim 54 wherein the device driver manager is implemented as a device driver.

57. The architecture defined in claim 54 wherein the device driver invocation manager and kernel device driver manager are implemented as device drivers.

58. The system architecture defined in claim 54 further comprising a user device driver manager to receive a command indicating an operation to perform with respect to the device driver.

59. The software architecture defined in claim 58 wherein the command may comprise one or more of installing the device driver, removing the device driver from the operating system kernel, replacing the device driver, and inspecting state of the device driver installed in the operating system kernel.

60. A system for use with an operating system kernel, the system comprising:
a device driver invocation manager to transparently intercept and redirect application requests through use of a stub method registered with the operating system kernel for a device driver interface, the stub method being called when an interface method on the device driver interface is called; and
a kernel device driver manager to register the device driver by registering a stub method for the device driver with the operating system kernel and to remove another device driver by unregistering its associated stub method from the operating system.
